(19) United States
(12) Patent Application Publication
(10) Pub. No.: US 2009/0205418 A1
(43) Pub. Date: Aug. 20, 2009

(54) PROCEDURE FOR CONTROLLING A DIGITAL FUEL LEVEL SENSOR

(75) Inventors: Buelent BARCIN, Stuttgart (DE); Michael Gerlach, Marbach A.N. (DE); Marc Chaineux, Stuttgart (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/332,993

(22) Filed: Dec. 11, 2008

(30) Foreign Application Priority Data
Feb. 14, 2008 (DE) 10 2008 009 154.5

(51) Int. Cl. G01F 23/00

(52) U.S. Cl. 73/290 R

(57) ABSTRACT

Procedure for controlling a digital tank fuel level sensor in a tank that is subjected to movements is thereby characterized, in that sloshing events are determined and in that the fuel level around the encoder position (205) in the tank is concluded from the number of sloshing events and in that from that the functioning of the tank fuel level sensor can be assumed.

### TECHNICAL FIELD

The invention concerns a procedure for controlling a digital fuel level sensor in a tank that is subjected to movements. Subject matter of the present invention is also a computer program as well as a computer program product with a program code, which is saved on a machine readable medium, for implementing the procedure.

### BACKGROUND

Filling levels of liquids, for example fuel levels in motor vehicles are detected for example by fuel level sensors. Thereby one has to differentiate between fuel level sensors, which have a continuing, kind of ‘analog’ detection of the filling level and level sensors, which only detect, whether there is liquid in an encoder position or not, so called digital level sensors. The first are for example used in fuel tanks of motor vehicles, the latter are preferably used for example in additional tanks for example of SCR-systems.

Present and future regulations stipulate now more and more strict controls of exhaust gas relevant components. Therefore reasonability tests have to be performed for example at exhaust gas relevant sensors, thus also level sensors, based on which it is decided, whether the sensor in question is functioning or not. At sensors, which only provided a digital signal in terms of the above said, a second sensor is often build in for controlling safety critical components.

Modern diesel vehicles use nowadays the so called SCR-technology. This means the selective catalytic reduction of nitrous gases in exhaust gases of combustion engines besides firing systems. The chemical reaction of the reduction is hereby selective. This means that not all exhaust gas components are reduced, but only the nitrous gases (NO, NO₂). The procedure of the reaction requires ammoniac, which is mixed to the exhaust gas. The products of the reaction are water and nitrogen. There are two types of catalysts. A first type of catalysts consists mainly of titanium oxide, vanadium pentoxide and tungsten oxide. The second type uses zeolites.

Vehicles do not use the required ammoniac in pure form anymore, but in the form of a watery urea solution, which is generally labeled with the trade name ‘AdBlue’. The solution is injected before the SCR-catalyst into the exhaust gas flow for example by a metering pump or an injector. Ammoniac and water emerge from the urea solution by a hydrolysis. The so produced ammoniac can react in a special SCR-catalyst at a certain temperature with the nitrous gases in the exhaust gas. The amount of the injected urea is depending on the (power operated) nitric oxide emission and therefore on the current engine speed and the turning moment of the engine. The consumption of the water urea solution amounts to about 2-8% of the consumed diesel fuel depending on the crude emission of the engine. For this reason a tank with an urea water solution has to be build in the motor vehicle and the fuel level has to be detected in this tank. The fuel level sensors that have been used so far in such SCR-systems are digital fuel level systems, which only control a load relieving by a resistance measurement. A controlling on to a so called frozen value, which is required by the regulations of the so called OBD 2 (on-board-diagnosis 2) as well as by new exhaust gas regulations, is hereby not possible without further ado.

The task of the invention is therefore to provide a procedure for controlling a digital fuel level system on to a frozen value, which can be realized easily and without the aid of additional hardware, especially additional redundant sensors.

### SUMMARY

This task is solved by the procedure according to this invention with the characteristics of the independent claim 1. The basic idea of the invention is to determine the sloshing events of a tank that is subjected to movements and to reason the fuel level around the encoder position in the tank from the number of sloshing events and from that the functioning of the tank fuel level sensor. The invention takes the advantage of the rationale that no sloshing can be measured anymore at a fuel level, which significantly exceeds the encoder and thus the encoder always stays activated. Reversely the encoder is always deactivated at a fuel level, whose level is set significantly below the encoder position. The frequency of the sloshing decreases first and then increases again in-between those two extremes, so that a fuel level around the encoder position can be determined from it in certain default limits.

Advantageous embodiments and improvements of the invention are subject matter of the subclaims that refer to claim 1.

Thus one advantageous embodiment provides for example to compare the sloshing events that have been detected by the fuel level system with the sloshing events that actually occurred. The sloshing events that actually occurred are thereby determined by at least the tank geometry and at least one parameter that indicates the driving status, especially a parameter that characterizes the acceleration and/or the deceleration of the vehicle and therefore of the tank.

According to an advantageous embodiment of the invention the tank fuel level that has been determined due to the amount of sloshing events is compared to the tank fuel level that has been determined with the aid of the tank fuel level sensor, and then a functioning of the tank fuel level sensor can be concluded, when the tank fuel level that has been determined with the aid of the tank fuel level sensor lies between default limits of the tank fuel level that has been determined due to the amount of sloshing events. Hereby accurate statements about the functioning of the fuel level sensor can be made, since the tank fuel level sensor level and the amount of the sloshing events correlate.

The procedure can be implemented very advantageous as a computer program and can run on a computer, for example a control unit. Thereby a computer program product can be provided with a program code, which is saved on a machine readable medium. That allows to bring in the program also in current control units and to provide corresponding enhancements at current SCR-systems insofar.

### BRIEF DESCRIPTION OF THE DRAWINGS

Embodiments of the inventions are shown in the drawings and further explained in the following description.

FIG. 1 schematically shows a block diagram of a procedure that makes use of the invention; and

FIG. 2 shows a diagram of the fuel level in a tank that is subjected to movements above the time to illustrate the procedure.

### DETAILED DESCRIPTION

The basic idea of the present invention is to use the frequency of sloshing events for controlling a digital fuel level system in a tank that is subjected to movements, especially in a tank of an urea water solution for SCR-systems.

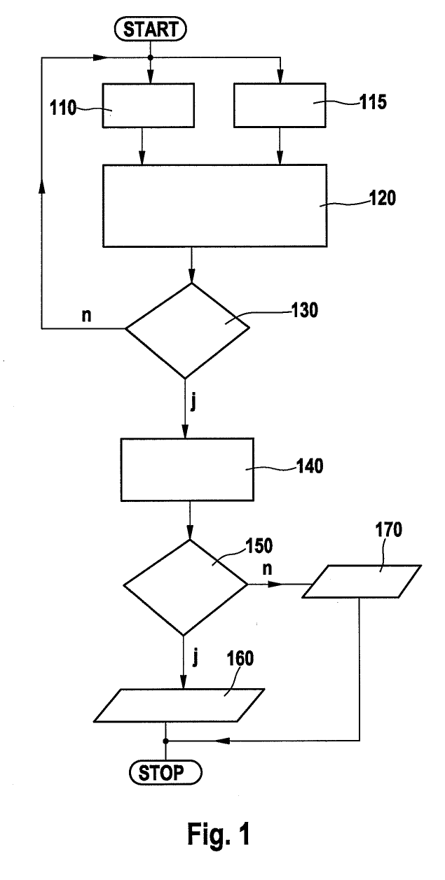

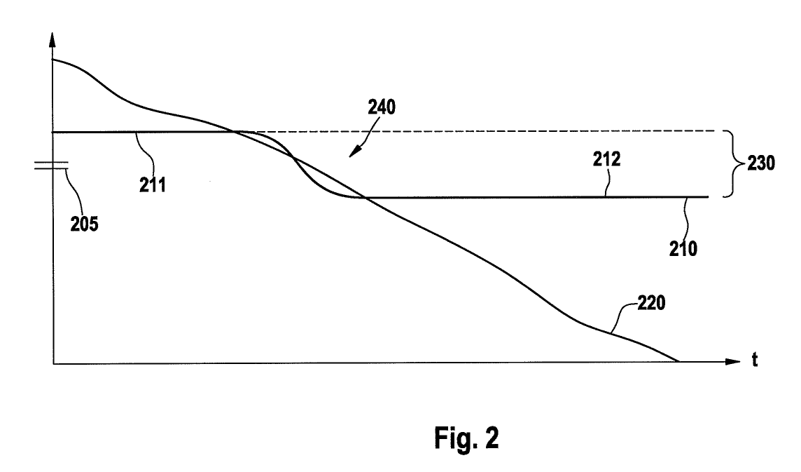

Therefore the number of sloshing events is determined, which occur for example during acceleration or deceleration of the vehicle and therefore of the tank. The invention takes thereby advantage of the rationale that no sloshing can be measured anymore at a fuel level, which significantly exceeds an encoder position 205 (FIG. 2), and that no sloshing can be measured either at a fuel level position, which significantly lies below the encoder position 205. This means that the slosh frequency is high at a filled tank. This is schematically shown in FIG. 2 by graph 211. The slosh frequency adopts a characteristically low value at a lower filling level, in other words when the tank is almost emptied, which is shown by graph 212 in FIG. 2. In a transition or slosh area 230 the slosh frequency increases initially and then decreases again as it is shown by the reasonability area 240. This slosh area is assigned to the encoder position 205. This means that the area 211, in which no sloshing can be measured, since the fuel level is higher than the encoder position, and the area 212, in which no sloshing is determined, because the fuel level is lower than the encoder position, are depending on the encoder position 205. The reasonability area 240 shows a quasi continuous curve, which allows to determine a filling level around the encoder position 205 in-between certain limits. Depending on the calculated fuel level, the tank geometry and at least one parameter, which characterizes the driving status, especially the acceleration or the deceleration, it is possible to compare the fuel level that has been determined by the sensor with the fuel level that has been determined by the number of sloshing events and thus to check on the functioning of the tank fuel level sensor. This is further explained in the following with regard to FIG. 1.

The number of sloshing events is determined in step 110. In addition in step 115 simultaneously at least one parameter is determined that characterizes the driving status, thus especially the acceleration or deceleration processes, which cause sloshing events. This can take place for example by a brake pedal analysis and/or by an accelerator pedal analysis.

The sloshing events that have been determined by the fuel level sensor are compared in step 120 with the actually measured sloshing events, for example by the brake pedal analysis. If the number of sloshing events does not correspond, a return to steps 120 and 115 takes place and the sloshing events are counted again. If the number corresponds, the fuel level is determined from the number of the sloshing events instep 140. Simultaneously the fuel level is measured by the fuel level sensor. The measured fuel level is compared to the fuel level that has been determined by the sloshing events in step 150. If both fuel levels do not correspond, an error output takes place in step 170. If both step corresponds, an output or an input into a memory device about the proper functioning of the tank fuel level sensor takes place in step 160.

The comparison of the fuel level that has been measured by the tank fuel level sensor with the fuel level that has been determined by the sloshing events takes place in such a way that the fuel level that has been measured with the aid of the sensor is compared to an applicable threshold. Thereby it s checked, whether the calculated fuel level corresponds with the position determination by the sloshing events. If the sensor value in-between the expected reasonability area 240 (FIG. 2) does not change under any circumstances anymore, a frozen sensor value can be concluded and this sensor value is shown in step 160 to the driver for example by a lamp or signalized by another notification signal.

The advantage of the described invention is that at a digital sensor principle a frozen value can be detected without further hardware, especially without having to use further redundant sensor. Thereby a controlling of exhaust gas relevant sensors is enabled that is OBD-2-compliant.

The claims are:

1. A method of controlling a digital tank fuel level sensor in a tank that is subjected to movement, the method comprising:
evaluating a number of sloshing events; and
determining a tank fuel level around an encoder position in the tank based on the number of sloshing events, wherein a functioning tank fuel level sensor can be assumed therein.

2. A method according to claim 1, further comprising comparing a number sloshing events that have been determined by the fuel level sensor with a number of actually occurring sloshing events.

3. A method according to claim 2, further comprising using at least a tank geometry and at least one parameter indicative of a driving status, especially an acceleration or a deceleration of the tank, for determining the actually occurring sloshing events.

4. A method according to claim 4, further comprising comparing the tank fuel level determined by the number of sloshing events to the tank fuel level that has been determined by the tank fuel level sensor, wherein a tank fuel level that has been determined by the tank fuel level sensor is positioned in-between a set of default limits of the tank fuel level that has been determined by the sloshing events, and wherein the functioning tank fuel level sensor is assumed therein.

5. A computer program to implement, if executed on a computer, a method of controlling a digital tank fuel level sensor in a tank that is subjected to movement, the method comprising: evaluating a number of sloshing events; and determining a tank fuel level around an encoder position in the tank based on the number of sloshing events, wherein a functioning tank fuel level sensor can be assumed therein.

6. A computer program product with a program code saved on a machine readable medium to implement, if executed on a computer or a vehicle control unit, a method of controlling a digital tank fuel level sensor in a tank that is subjected to movement, the method comprising: evaluating a number of sloshing events; and determining a tank fuel level around an encoder position in the tank based on the number of sloshing events, wherein a functioning tank fuel level sensor can be assumed therein.
